(19) United States
(12) Patent Application Publication
(10) Pub. No.: US 2002/0155832 A1
(43) Pub. Date: Oct. 24, 2002

(54) Wireless telemetry system

(76) Inventors: Michael J. Stucky, Canton, MI (US); Paul F. Nowak JR., Ann Arbor, MI (US); David M. Weinerth, Ann Arbor, MI (US); Jan D. Wolter, Ann Arbor, MI (US)

Correspondence Address: Jeremy J. Curcuri, Brooks & Kushman P.C., 22nd Floor, 1000 Town Center, Southfield, MI, 48075-1351, US

(21) Appl. No.: 09/837,854

(22) Filed: Apr. 18, 2001

(51) Int. Cl. H04Q 7/20

(52) U.S. Cl. 455/426; 455/420

(57) ABSTRACT

A wireless telemetry system includes a remote telemetry unit including a transceiver, control logic, at least one programmable register, and at least one sensor. The remote telemetry unit is operable in a run mode in which data is acquired from the at least one sensor and transmitted by the transceiver in accordance with the value in the at least one register. In a program mode, receipt by the transceiver of calls to identity tags causes the control logic to modify the value in the at least one register, changing the way that the remote telemetry unit operates in the run mode.

### BACKGROUND OF THE INVENTION

1. Field of the Invention

The present invention relates to telemetry systems.

2. Background Art

Existing telemetry systems are now used in the industrial gas industry. Before the use of telemetry systems became common, there were several problems associated with monitoring the use of industrial gases. For example, since industrial gases like argon, oxygen, and nitrogen are not metered, the data collection activity was centered on deliveries. The only means of understanding usage was by tallying up delivery tickets, which is a meticulous task that provides benefits only over the longer term. While telemetry systems connected through hard wired phone lines are now commonplace on newer and heavy usage tanks, these phone line telemetry systems have their own set of issues such as power/phone line availability and reliability, plus capital costs.

Recently, wireless telemetry systems have become available. However, the development of the wireless telemetry system industry is still in its infancy and existing systems have limited features. As such, there is a need for a wireless telemetry system that has improvements over existing wireless telemetry systems, and which may be used in the industrial gas market as well as in other markets.

### SUMMARY OF THE INVENTION

It is, therefore, an object of the present invention to provide a wireless telemetry system that includes a remote telemetry unit operable in a run mode in which data is acquired from at least one sensor and transmitted by a transceiver in accordance with a value in at least one register, wherein the register is programmable from a remote site.

In carrying out the above object, a wireless telemetry system is provided. The wireless telemetry system comprises a remote telemetry unit (RTU) including a transceiver, control logic, at least one programmable register holding a value, and at least one sensor. The remote telemetry unit is operable in a run mode and in a program mode. In the run mode, data is acquired from the at least one sensor and transmitted by the transceiver in accordance with the value in the at least one register. The transceiver has a first group of identity tags and a second group of identity tags. Receipt by the transceiver of a call to an identity tag in the first group causes the remote telemetry unit to enter the program mode. Receipt by the transceiver of a call to an identity tag in the second group when the remote telemetry unit is in the program mode causes the control logic to modify the value in the at least one register remotely. Advantageously, by providing a way to modify the value in the at least one register, the remote telemetry unit may be remotely programmed. It is appreciated that the identity tag may take a variety of different forms depending upon the implementation chosen for communications (for example, satellite, cellular, or any other form of wireless communications). Further, in a suitable implementation, the identity tags are mobile identification numbers, and the transceiver is a cellular transceiver.

In a suitable implementation, the first group of identity tags includes a plurality of identity tags. In a suitable implementation, the second group of identity tags includes a plurality of identity tags. In a preferred implementation, the at least one register includes a plurality of registers. The first group of identity tags includes a first tag and a second tag.

When the remote telemetry unit is in the run mode, receipt by the transceiver of a call to the first tag causes the at least one sensor to acquire data and the transceiver to transmit the data. Receipt by the transceiver of a call to the second tag when the remote telemetry unit is in the run mode causes the remote telemetry unit to switch from the run mode to the program mode. When the remote telemetry unit is in the program mode, receipt by the transceiver of a call to the first tag causes the transceiver to change a selected register of the plurality of registers. Receipt by the transceiver of a call to the second tag when the remote telemetry unit is in the program mode causes the remote telemetry unit to switch from the program mode to the run mode.

Further, in a preferred embodiment, the at least one register includes a plurality of bits. The second group of identity tags includes a corresponding plurality of tags. When the remote telemetry unit is in the program mode, receipt by the transceiver of a call to one of the tags in the second group of tags causes the corresponding bit to toggle, changing the value held in the at least one register, thereby programming the remote telemetry unit.

Preferably, there are many registers that may be programmed remotely to control operations of the remote telemetry unit in the run mode. For example, the at least one register may include an operations register having bits that specify at least one of the following: frequency of regularly scheduled transmissions, unit interrogation requests, switch systems, retrieve memory, and reset counters. For example, the at least one register may include at least one alarm register corresponding to the at least one sensor. The alarm register has bits that specify alarm level for the at least one sensor. Further, for example, the at least one register may include a fill alarm register having bits that specify a fill alarm level.

In preferred embodiments, the system further comprises a backend server that receives a message indicative of the data transmitted by the transceiver. That is, the remote telemetry unit, in the run mode, acquires data from the at least one sensor and transmits the data with the transceiver in accordance with the programmed value or values in the at least one register. The transmission from the transceiver passes through the network of the wireless service provider which may be a cellular service provider, and is eventually received by the backend server. The backend server may be located on a global network such as the Internet. The collected data may be arranged in a suitable database that may be accessed via the Internet.

The advantages associated with embodiments of the present invention are numerous. Embodiments of the present invention provide a remote telemetry unit that may be used in many applications including the industrial gas industry. Of course, the remote telemetry unit may be useful in other industries such as the industrial truck industry (for tracking engine hours or hydraulic lift hours, etc.). Further, embodiments of the present invention are not limited to use in any specific industries and may be used in a wide variety of inventory management and equipment monitoring applications. In accordance with the present invention, the remote telemetry unit includes programmable registers so that the remote telemetry unit may be remotely programmed. In preferred implementations, a backend server located on the Internet is used to program the remote telemetry unit so that the remote telemetry unit may be effectively programmed from almost anywhere.

The above object and other objects, features, and advantages of the present invention will be readily appreciated by one of ordinary skill in the art in the following detailed description of the best mode for carrying out the invention when taken in connection with the accompanying drawings.

### BRIEF DESCRIPTION OF THE DRAWINGS

FIG. 1 is a wireless telemetry system made in accordance with the present invention, illustrating the remote telemetry unit, the wireless network and wireless service provider, and the backend server at the application service provider;

FIG. 2 illustrates a remote telemetry unit of the present invention in a suitable enclosure;

FIG. 3 illustrates the mobile identification numbers and their functions in a preferred embodiment of the present invention;

FIG. 4 illustrates an example of a preferred remote telemetry unit programming protocol being used to remotely program a remote telemetry unit;

FIG. 5 illustrates the RTU operations program register in a preferred embodiment;

FIG. 6 illustrates bits within the RTU operations program register and the corresponding frequency of regularly scheduled transmissions in a preferred embodiment;

FIG. 7 illustrates alarm registers in a preferred embodiment; and

FIG. 8 illustrates a fill alarm register in a preferred embodiment.

### DETAILED DESCRIPTION OF THE PREFERRED EMBODIMENT

With reference to FIG. 1, a wireless telemetry system made in accordance with the present invention is generally indicated at 10. Data source 12 is being monitored by remote telemetry unit (RTU) 14 of system 10. Data source 12 may be a transducer output that indicates contents of an industrial gas storage tank, or may be an output from an industrial vehicle that indicates engine hours or some other data. That is, the RTU may be used to monitor anything, but is particularly useful in the industrial gas and vehicle industries. Further, embodiments of the present invention may be used in a variety of inventory management and equipment monitoring applications. Remote telemetry unit 14 includes a transceiver 16, control logic 18 such as a microprocessor, at least one programmable register 20, and at least one sensor 32. Preferably, sensor 32 is a plurality of sensors. Further, preferably, there are a plurality of registers 22, 24, 26, 28, 30. Remote telemetry unit 14 monitors data source 12 with sensors, and the data acquired from the sensors is transmitted by transceiver 16 in accordance with the values in the registers 20. That is, control logic 18, which may be suitably implemented as a microprocessor or microcontroller, acquires data with the sensors and transmits the data with the transceiver in a manner consistent with the values contained in the registers. The registers, advantageously, may be remotely programmed providing a remote telemetry unit with tremendous flexibility.

As shown, transceiver 16 is in communication with cellular tower 34. Within the cellular network, tower 34 is connected to switch 36, which is connected over wireless network 38 to the wireless service provider 40. Wireless service provider 40 is connected with application service provider (ASP) 44 over network 42. Network 42 may be the Internet. As such, in accordance with the present invention, application service provider 44 may communicate in both directions with telemetry unit 14 by sending or receiving information over network 42, wireless service provider 40, wireless network 38, switch 36 and tower 42 to or from remote telemetry unit 14. Of course, it is appreciated that other networks may also be suitable and that the use of a cellular network and the Internet is preferred, but not required. It is advantageous that network 42 be the Internet so that remote users at a computer 46 may access application service provider 44, and therethrough, communicate with remote telemetry unit 14. In addition, data collected by remote telemetry unit 14 and sent to application service provider 44 may be viewed by a user at computer 46. Preferably, provider 44 stores collected data in a database viewable by others that log on to the ASP server.

In a preferred implementation, communications with remote telemetry unit 14 utilize the control channel of the cellular network. Cellular communications through cellular control channels are further explained in U.S. Pat. Nos. 5,526,401; 5,546,444; 5,873,043; and 6,125,275, all of which are hereby incorporated by reference in their entirety. These four patents describe a suitable implementation for communication between remote telemetry unit 14 and wireless service provider 40. Communications between wireless service provider 40 and application service provider 44, as well as communications between application service provider 44 and a remote user at computer 46 over Internet 42 or any other suitable network may be implemented in any manner known in the art. Further, in a cellular transceiver implementation, a mobile identification number is a suitable identity tag. Of course, other tags may be suitable in other implementations.

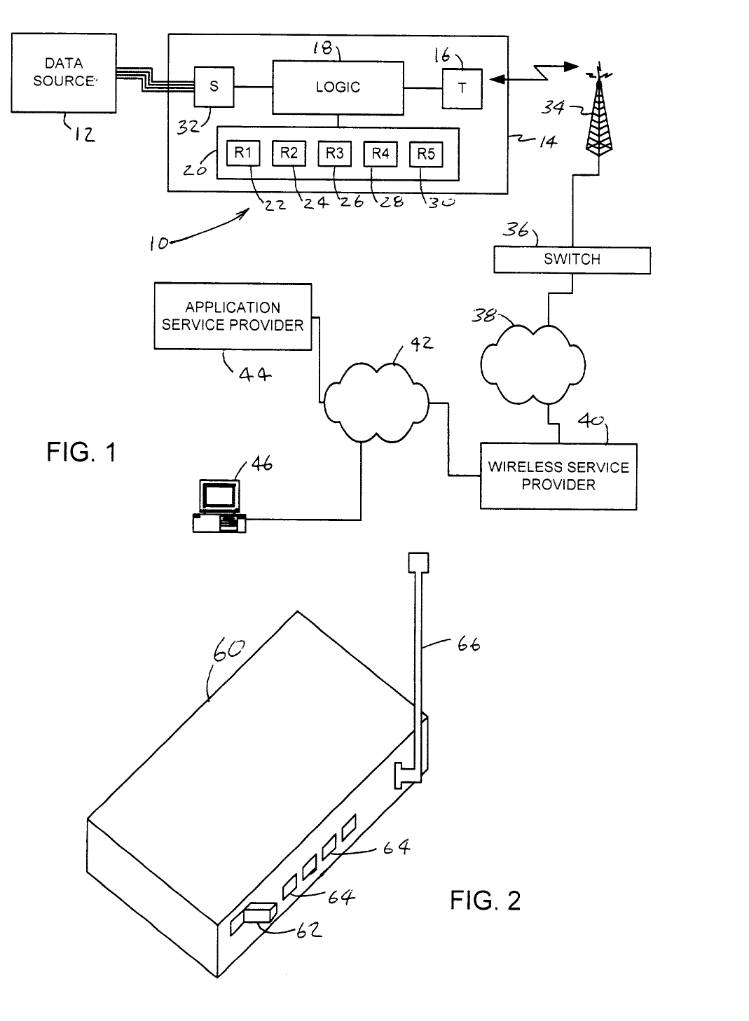

FIG. 2 illustrates a remote telemetry unit 60 in a suitable enclosure to allow the remote telemetry unit to be used in industrial applications such as industrial gas monitoring or industrial equipment monitoring. Remote telemetry unit 60 has an on/off switch 62, sensor inputs 64, and an antenna 66 connected to the internal transceiver 16. As explained above, unit 60 collects data and sends data to ASP 44, ASP 44 maintains a database and has a server accessible to remote user 46. In the present invention, ASP 44 or remote user 46 may view data in the database, and may communicate with RTU 14. The present invention provides a programmable RTU with programmable registers 20. The values in registers 20 direct control logic 18 as to operation of RTU 14 in the run mode. Below, preferred RTU operating protocols are described. It is appreciated that the present invention does more than simply send commands to RTU 14, the present invention comprehends remote programming of RTU 14. The flexibility provided by an RTU made in accordance with the present invention is to be appreciated. For example, register bits may be changed to change the way that the RTU operates. Further, the control logic may be changed so as to change the meaning of the register bits. Further, additional registers may be added to provide additional programming options.

RTU OPERATING PROTOCOLS

The following description explains an exemplary implementation of RTU operating protocols in accordance with the present invention. As such, the below description is for exemplary purposes and is not meant to limit the broad scope of the invention as described previously, and further, many modifications may be made to the protocol while still remaining within the scope of the invention. Further, the example is directed to an industrial storage tank monitoring application and uses cellular communications where the identity tag is a mobile identification number. However, one of ordinary skill in the art appreciates that certain modifications may be made for other applications. That is, embodiments of the present invention may be used in a variety of inventory management and equipment monitoring applications. Further, the example RTU operating protocols disclosure is divided into six parts: Introduction, MIN Identification, RTU Power Up Procedure, RTU Programming Protocol, Program Registers, and Data Transmissions.

1.0 INTRODUCTION

The remote telemetry unit (RTU) monitors multiple analog and digital signals. The unit is powered in any suitable manner such as 110V AC, battery, or solar power. Alarm levels, transmission frequency, and other operating parameters are remotely programmable through the application service provider (ASP) website.

All transceivers are programmed with ten mobile identification numbers or MINs at the application service provider (ASP), before installation of the RTU. The first two MINs are unique to the individual RTU. The last eight MINs are broadcast MINs that are programmed into all RTUs.

Ideally, the programming procedure should accomplish the following objectives:

1. Program and verify MINs in the MIN masks of the transceiver.

2. Associate RTU number to MINs in the transceiver.

3. Download RTU number and MINs into backend.

A suitable transceiver is the AM-10 cellular transceiver available from Ericsson or the 7700 transceiver available from Standard. An RTU may be calibrated by putting a set current into the analog-to-digital converter (sensors 32) and having the results transmitted to the backend. The backend is located at ASP 44 and includes a server and a database. These results will serve as an RTU-specific calibration curve for all future results from that specific RTU.

The preferred RTU can operate in two modes: (1) Data Transmission Mode and (2) Program Mode. The RTU operates a majority of the time in data transmission mode, when typical monitoring activities are active. The RTU is put into program mode to receive programming instructions from the backend. The instructions are stored in register bank 20 and are executed by logic 18.

In the data transmission mode, the RTU is programmed to transmit data at regularly scheduled intervals. At the end of each time interval, a transmission containing three data points from each active input is sent to the ASP hub 44. For N active inputs, there will be N regularly scheduled transmissions with data obtained at the following times: current input reading, input reading at T/3 hours ago, where T is the time interval of transmissions in hours, and input reading at 2 T/3 hours ago.

In addition to the preferred regularly scheduled transmissions, the RTU can transmit data under a number of conditions. The RTU can:

Automatically transmit the current product level when a given input falls below a default/programmed alarm level. Each input can have a unique alarm level.

Be polled from the ASP website to transmit the current input levels on all active inputs.

Transmit monitored data at the end of a product fill. The RTU keeps track of the previous two hours of input level and determines if product is being added to the tank. At the end of the product fill, the RTU will transmit a fill alarm to the backend. This alarm transmission will contain the current product level, the level at the start of the fill, and the number of minutes between the two readings.

Two minutes after AC power is cut to the unit (in an AC powered unit), the RTU will transmit a special response indicating that the unit is on battery power. This response will contain current and stored input level information. After transmitting the response, the RTU will turn off power to the gauge and cellular transceiver, and implement other power saving features. The RTU will not leave this mode until AC power has returned. Of course, it is appreciated that similar power savings features may be used in other types of units, such as a solar unit.

A special operating mode of the data transmission mode is the “Alarm Only” Transmission Frequency setting. In this mode, there are no regularly scheduled transmissions. Transmissions are only initiated under alarm conditions. To increase the number of alarms on the unit, after an alarm is triggered, the alarm level for the input will be lowered by the amount contained in the Fill Alarm Program Register. The process of lowering the alarm level after the alarm is triggered will continue until the alarm level reaches negative values. Should the unit detect a fill, the alarm will be set to the highest alarm value available that is below the tank level after the fill. This alarm-lowering process will only be active while in “Alarm Only” mode.

2.0 MIN IDENTIFICATION

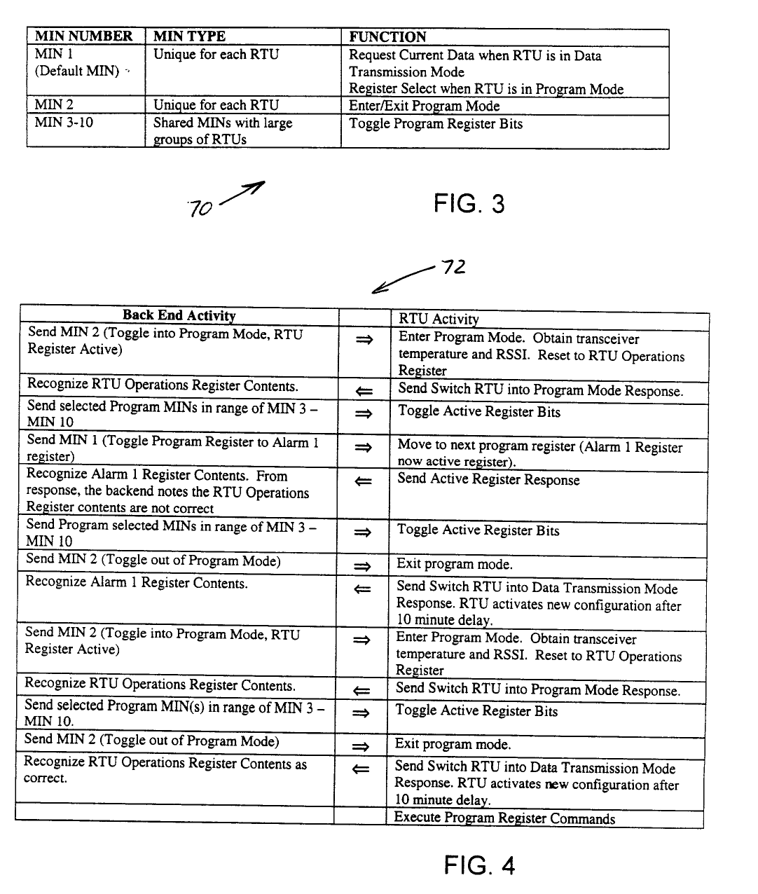

Each RTU will be programmed with ten MINs (70, FIG. 3). Of course, other suitable identity tags may be used in other implementations. The first two MINs (MIN 1 and MIN 2) will be unique to each RTU. All data transmissions to the ASP 44 will register using MIN 1. Reception of a forward page with MIN 2 toggles the RTU between the Data Transmission Mode and Program Mode. When the RTU is in the data transmission mode, the reception of a forward page with MIN 1 will trigger the RTU to obtain a current reading of all active inputs and transmit the current values back to the application service provider (ASP). When the RTU is in the program mode, reception of a forward page with MIN 1 will toggle the RTU through the program registers 20, used in programming the RTU.

The next eight MINs will be inserted into, and shared by, a large number of RTUs. These MINs are used to program the RTU. When an RTU is in program mode, a reception of these MINs toggles the bits in the program register 20, which sets or modifies the RTU configuration.

3.0 RTU POWER UP PROCEDURE

When an RTU is attached to AC power, an LED will turn on indicating power to the unit. Similar LED illumination may be employed in units powered in other ways, such as by solar power. After receiving power, the RTU begins a scan of the cellular service in the area. It will scan both the A side carrier and the B side carrier to determine which has the greater signal strength. The RTU will attempt to register a message with the cellular service provider beginning with the carrier that possesses the greatest local signal strength. Upon receipt of the RTU generated registration, the cellular service provider gateway forward pages the RTU. The reception of this forward page triggers the RTU to illuminate an LED indicating that cellular service provider service is active. Thirty minutes after receiving this page, the RTU will transmit a Carrier Selection Response. Other transmission options during installation include data from active inputs. The carrier selection message indicates that the RTU is operational, ready to be programmed, and informs the ASP of the selected carrier channel and signal strengths. After transmitting the Carrier Selection Response, the RTU will lay dormant for 12 hours and then begin its normal operating cycle. The RTU is assumed to be installed during day time hours, thus, the 12 hour delay will begin the transmission cycle during the less cellular-traffic intensive night-time hours.

During the installation process, the service technician can hook up any input wires into the connector block on enclosure 60 containing inputs 64. An LED indicator light will turn on when the microcontroller receives a valid input signal from any of the four possible inputs.

4.0 RTU PROGRAMMING PROTOCOL

The preferred RTU can be programmed to:

1. Alter the frequency of regularly scheduled transmissions.

2. Begin the cycle of regularly scheduled transmissions at a particular time of day.

3. Set an alarm (i.e. automatic transmission alarm) for each of the four possible inputs.

4. Set the required increase in input level to trigger a fill alarm.

5. Send a “fill” alarm transmission for any number of the four possible inputs.

6. Switch cellular carriers.

7. Suspend all data transmissions until further notice.

8. Return RTU status information.

The RTU is programmed using “program registers” 20 located in the RTU. Each program register is 8-bits. When the RTU is in program mode, a single program register is active and each bit in the active register can be toggled to the opposing binary value upon receipt of an associated MIN (MINs 3-10, inclusive). The RTU logic 18 will then translate these binary values into executable actions.

There are six program registers in the exemplary RTU.

1. RTU Operations Register: controls data transmission frequency, request of RTU status, cellular system selection, memory retrieval, and timing of transmission schedule.

2. Alarm 1 Register: controls level of alarm on the first input.

3. Alarm 2 Register: controls level of alarm on the second input.

4. Alarm 3 Register: controls level of alarm on the third input.

5. Alarm 4 Register: controls level of alarm on the fourth input.

6. Fill Alarm Register: controls the amount of increase on an input to trigger a fill alarm, and the suspension of transmission operation.

To enter into the program mode from the data transmission mode, a forward page must be sent to the unit with MIN 2. Recognition of this MIN places the RTU into program mode, resets the active register to the RTU Operations Register, and sends a “Switch RTU into Program Mode Response” to the backend using MIN 1. A receipt of a forward page from MIN 3-MIN 10 will toggle the associated binary value of the active program register. In program mode, a receipt of MIN 1 toggles the active register to the next program register. To exit the program register, a receipt of MIN 2 is required. Any data requests or unit operation changes will not become active until 10 minutes after the RTU exits program mode.

A possible programming scenario is shown at 72 in FIG. 4. In this scenario, only the RTU Operations and Alarm 1 registers are being changed but a forward page (Program MIN) to the RTU Operations register does not get through to the RTU. Thus, a second attempt to program the RTU Operations register is required. The arrow in the middle column signifies the direction of information flow. To read the table in the proper order, read down the rows beginning with the column closest to the origination of the direction arrow.

There are six program registers. These registers control the RTU operation. While in Program Mode, each bit in an active register can be toggled to the opposing binary value by receiving a forward page with the associated MIN. For example, if the RTU Operations Register is active, sending a forward page of MIN 3, MIN 4, or MIN 5 can change the frequency of regularly scheduled transmissions. Each register is discussed in detail below.

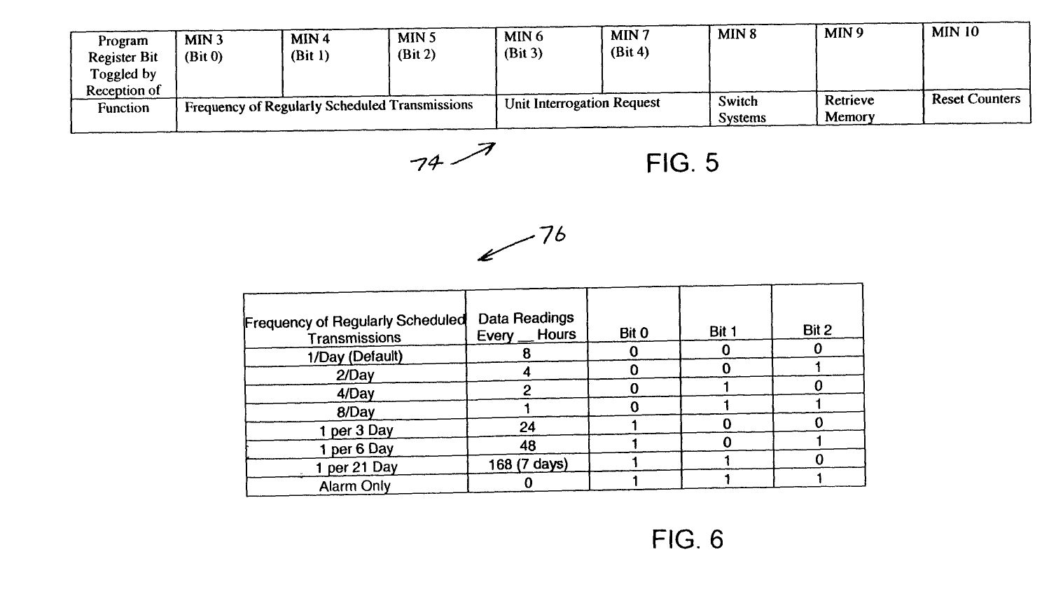

The RTU Operations Register (74, FIG. 5) controls five operations:

1. Frequency of regularly scheduled transmissions.

2. Unit interrogation requests.

3. Switch cellular carriers command.

4. Retrieve data points stored in memory.

5. Reset timer counters to zero.

Frequency of Regularly Scheduled Transmissions

There are eight options for the frequency of regularly scheduled transmissions. FIG. 6 at 76 shows current options. Others are possible. When in program mode, reception of MIN 3, 4, or 5 will cause the RTU to initiate a Reprogram Response.

In Alarm Only mode, there are no regularly scheduled transmissions. Transmissions are only initiated under alarm conditions. To increase the number of alarms on the unit, after an alarm is triggered, the alarm level for the input will be lowered by the amount contained in the Fill Alarm Program Register. The process of lowering the alarm level after the alarm has been triggered will continue until the alarm level reaches negative values. Should the unit detect a fill, the alarm will be set to the highest alarm available that is below the tank level after the fill. Bits 0, 1, and 2 will NOT clear after RTU exits Program Mode. Bits 0, 1, and 2 should not be set if Bit 6 is set.

Unit Interrogation Requests

Two bits are set aside to request information on the status of the transceiver. These bits can command the RTU to send information on the Service Status of the transceiver, the most recent Registration Information, or information on both the Service Status and Registration Information. When the RTU exits Program Mode, the requested information will be retrieved from the RTU and sent in the appropriate number of transmissions.

The Service Status includes the information of the monitoring control channel, the received signal strength indicator, and the number of cell sites “seen” by the RTU. The Registration Information includes the control channel used in the last registration and the carrier channel, A or B. Bits 3 and 4 will clear after RTU exits Program Mode.

Switch Systems

If Bit 5 is set, the RTU will attempt to switch cellular service providers. For a switch to occur, both local carriers must carry messages of the cellular service provider, that is, carry analog control channel messages that are routed to the cellular service provider. This command could be used in cases where cellular service has been faulty, and switching local carriers might provide more reliable coverage. This command will force the RTU to determine if the other cellular service provider carries messages of the cellular service provider. If it does, the RTU will begin operations on the new carrier. At the end of the cellular service evaluation, the RTU will initiate a Switch Service Response. This transmission will contain information on the received signal strengths of both carriers, and the currently selected carrier for operation (A or B). It is the responsibility of the backend to determine if the carrier has switched carriers based upon the last Switch Service Response. Bit 5 will clear after RTU exits Program Mode.

Retrieve Memory

If Bit 6 is set, the RTU will initiate a Retrieve Memory Response, transmitting all data currently stored in memory. As opposed to the Reprogram Response, which is initiated by changing the regularly scheduled transmission frequency or the reset counters command, this command will not clear memory, or disrupt the current transmission cycle. This command was designed to be used after a missed regular transmission. If the RTU failed to send data at the scheduled time, it will attempt to send data for the next four minutes. After the final attempt fails, the RTU will not clear the memory registers until the next analog-to-digital conversion, at T/3 hours into the next cycle. Bit 6 will clear after RTU exists program mode. Bit 6 should NOT be set when setting Bits 0, 1, 2, or 7.

Reset Counters

If Bit 7 is set, the RTU will reset all timing counters to zero and initiate a Reprogram Response. The purpose of this command is to control the time of transmission. For example, if a scheduling center wanted the data sent at 4 pm every day (T=24 hours), ASP would issue a “Reset Counters” command at 4 pm, and the transmission cycle would be properly timed. Bit 7 will clear after RTU exits Program Mode. Bit 7 should NOT be set if Bit 6 is set.

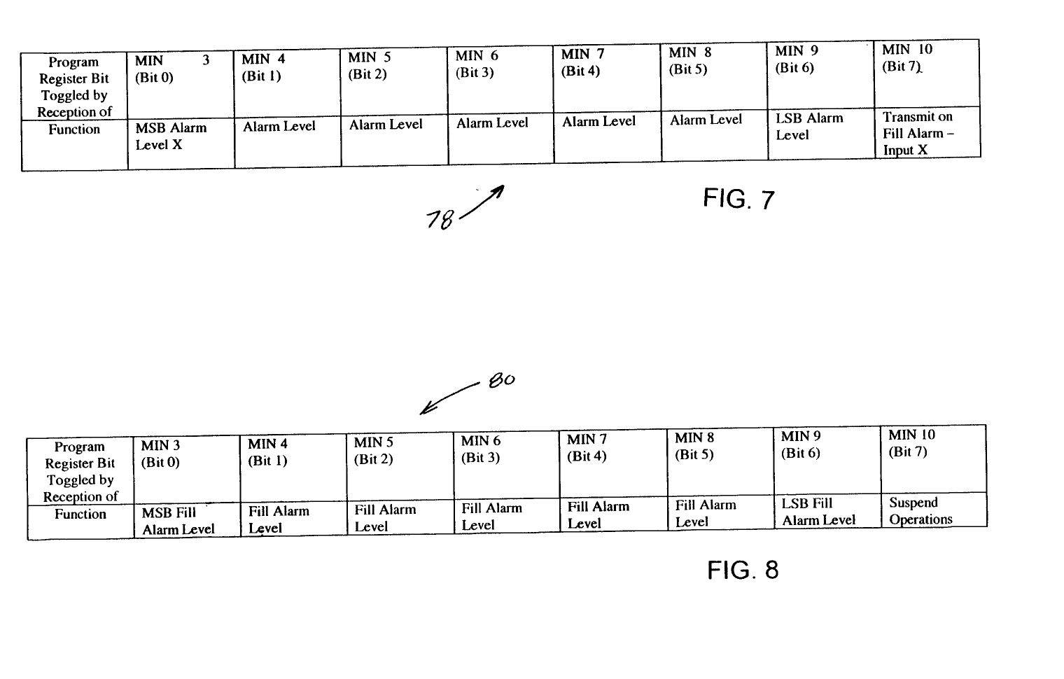

Program Registers 1-4 (78, FIG. 7) control the Alarm Level of Inputs 1-4, respectively. Each alarm is 7-bits, with bit 0 being the Most Significant Bit (MSB) and bit 6 being the Least Significant Bit (LSB). The last bit in this program register is the command to transmit on a fill alarm from the input related to that alarm register. For example, Program Register 1 is Alarm 1 Register. This register controls the low alarm level that initiates an “Alarm Low” Response. It also controls whether an “Alarm Fill” Response is issued based on the signal levels in input 1. These program register bits will not clear when the RTU exits Program Mode.

Program Register 5 (80, FIG. 8) controls the required increase of the 8-bit input to initiate a fill alarm. If the signal level increases the fill alarm register amount in a set period of time (for example, a suitable period of time is 2 hours) the fill alarm is triggered, but will not initiate an automatic transmission “Alarm Fill” Response unless the “Transmit on Fill Alarm” bit for the given input is set. The transmit bit is contained within each Alarm Register.

Suspend Operations

If Bit 7 is set, the RTU will suspend all transmission operations until further notice. The RTU will continue to listen for forward pages during the suspension of transmission operations. The bit can be cleared to resume normal transmission operation. These program bits will persist after RTU exits Program Mode.

6.0 DATA TRANSMISSIONS

The RTU will transmit using MIN 1, the default MIN. Each transmission will contain 8 hex digits. The first six digits contain monitoring data. The 7^{th} hex digit identifies the type of transmission, while the 8^{th} hex digit will either contain additional data or identification information, depending upon the type of transmission. Currently, there are 14 types of transmissions. The formats for these transmissions are discussed below. As mentioned previously, the preferred transmissions utilize the 32 bit ESN portion of a control channel transmission, such as a cellular registration transmission.

Response Type 0: Regularly Scheduled Transmissions

The RTU sends out regularly scheduled transmissions at a programmable time interval, T. During this time interval, the RTU obtains three readings from each active input. An input may be defined as active in a variety of ways such as, for example, when the voltage is above 0.90 V. Immediately after the last of these three readings, the RTU transmits data obtained during the last time period. Each regularly scheduled transmission contains the three data readings from a single input. Thus, for N active inputs, N regularly scheduled transmissions are sent to the application service provider (ASP), each transmission staggered five minutes from the previous transmission. For example, if two inputs are active, T=24 hours, and the regularly scheduled transmission occurs at 10 PM . . . at 10 PM three data points from Input 1 are transmitted to the ASP. These data points were obtained at 10 PM, 2 PM, and 6 AM of the current date. At 10:05 PM three data points from Input 2 are transmitted. These data points were obtained at 10 PM, 2 PM, and 6 AM. If a local registration failure occurs (i.e. the RTU fails to make contact with the cellular tower during transmission) the RTU will attempt to resend the failed transmission every minute for the next four minutes (a total of five transmission attempts).

Response Type 1: Response to Data Request

When the RTU receives a forward page with MIN 1, the RTU will immediately take readings of all active inputs. The RTU will then send these data to the ASP with one transmission for each active input.

Response Type 2: Low Alarm

The purpose of the low alarm is to immediately alert the backend that an alarm level has been breached. When the programmed alarm level is breached, the RTU will immediately poll all of the active inputs. After the last input has been read, the RTU will send these data to the ASP with one transmission per each active input. Each input can have a unique low alarm level remotely programmed into the RTU.

Response Type 3: Fill Alarm

The purpose of the Fill Alarm is to alert the gas supplier/end-user that a tank has been filled with product. To detect a fill, the RTU obtains input level readings every few minutes and stores these readings for two hours. During this two hour period, if the level of an input increases the amount stored in the Fill Program Register, a Fill Alarm is triggered. When a Fill Alarm is triggered, the RTU will monitor the triggered input and wait until the input level stops rising. When the level stops rising the RTU will transmit the “filled” input level, the input level just prior to the fill (defined as the lowest value in the 2 hour period), and the amount of minutes between the two readings. The backend will be able to calculate the time of the initial reading from this time difference. In contrast to the low alarm, the fill alarm will only transmit data from the input that initiated the fill alarm. All four inputs can initiate fill alarms, but the default is to have only the first input initiate the alarm. For inputs 2, 3 and 4 to generate fill alarms, Bit 7 of the associated alarm register must be set high.

Response Type 4: Reprogram Response

When in the program mode, a command to change the regularly scheduled transmission frequency or to reset the program timers will initiate a “Reprogram Response” when the RTU exits program mode. These two commands may be received by the RTU at any time during normal operation and as a result, the RTU may have already obtained one or two data points during the current transmission cycle. When the RTU receives either of the two commands, the RTU will obtain a current reading of the active inputs. The “Reprogram Response” will contain the current input readings and will also contain any and all non-transmitted data obtained during the previous transmission cycle. Specifically, the Response Type 4 will always consist of the most current reading in Bits 0-7. It may also contain data in Bits 8-15 (if only one data point has been obtained during the transmission cycle) and Bits 16-23 (if two data points have been obtained during the transmission cycle). It is the responsibility of the backend to recognize these different data response formats and to calculate the time of their readings based upon the previous transmission cycle period.

Response Type 5: Battery Alarm

When AC power is cut to the RTU (in an AC powered RTU), the RTU will obtain a current reading of all active inputs. Similar to the Reprogram Response, the unit will transmit this/these reading and all un-transmitted data stored in the RTU memory. Thus, a Battery Alarm will contain data in Bits 0-7, but may also contain data in Bits 8-23. If only a single input is monitored, the battery alarm transmission will be sent twice, to insure the backend receives the message. If more than one input is monitored, the transmission for each input will only be transmitted once, unless sufficient power exists for multiple transmissions. The RTU will then power down to conserve power. Similar functionality may be provided for other types of units such as solar units.

Response Type 6: AC Online

When AC power is restored to an RTU, the RTU obtain a current reading of all active inputs and transmit this data. The purpose of this response is to alert the backend that power has been restored to the unit, and the current levels of all active inputs.

Response Type 7: Retrieve Memory

The Retrieve Memory command, initiated from the RTU Operations Program Register, is a method to retrieve all data stored in memory without disrupting the current transmission cycle. This command will not clear the memory registers. The purpose of the command is to give the ASP a method to obtain data that might have failed to get transmitted during a regularly scheduled transmission. Under current design, the RTU has three memory registers for each input. These registers will clear after a regularly scheduled transmission registration (local transmission success signal). However, if the transmission fails locally, the memory will not clear until the next analog-to-digital conversion, T/3 hours into the next transmission cycle. This provides the ASP with T/3 hours to determine if the RTU has failed to transmit data and to retrieve the data before it is erased.

Response Type 8: Switch RTU into Program Mode Response

When the RTU receives a forward page of MIN 2, the RTU toggles to the opposing operating mode (i.e. Data Transmission Mode to Program Mode or Program Mode to Data Transmission Mode). To notify the backend of the RTU status, a specific response is transmitted when the RTU enters Program Mode. The response includes the received signal strength indicator (RSSI) and the transceiver temperature, and the currently active program register (it should always be the RTU Operations Register-0).

Response Type 9: Switch RTU into Data Transmission Mode Response

When the RTU receives a forward page of MIN 2 while the in the Program Mode, it will switch to the Data Transmission Mode. To notify the backend of the RTU status, a specific response is transmitted when the RTU enters Data Transmission Mode. The response shows the last active program register contents.

Response Type A: Switch Active Register Response

This message is only sent while the RTU is in program mode. When the RTU receives a forward page with MIN 1, the active register is cycled to the next register (or, if at the last register, the RTU will cycle back to Program Register 0). The response includes the current register contents, the last register contents (updated with the new program commands), and the active register number.

Response Type B: Carrier Selection Response

This message is sent when the RTU is first installed, and can also be initiated from a command to the RTU Operations Register. This response indicates the signal strengths of both carriers, and the carrier that was selected for normal operation.

Response Type C: Unit Interrogation 1

The RTU Operations Register contains two bits that allow for rudimentary interrogation of RTU status. A signal of 01b in the RTU Register Bits 3 and 4 requests a service status check be performed on the cellular transceiver, and the results of this inquiry be transmitted back to the application service provider (ASP). The data include the received control channel (the monitoring control channel), the received signal strength indicator, and the number of cell sites seen by the RTU.

Response Type D: Unit Interrogation 2

The RTU Operations Register contains two bits that allow for rudimentary interrogation of RTU status. A signal of 10b in the RTU Register Bits 3 and 4 requests the control channel number used to transmit the Switch RTU into Data Transmission Mode Response be sent back to the application service provider (ASP). In addition the cellular channel is transmitted (A or B side).

It is appreciated that although the above description is tailored to a specific application of the present invention for tank monitoring, embodiments of the present invention may be used for many other applications. For example, embodiments of the present invention may be useful for monitoring industrial equipment. For example, a remote telemetry unit may be mounted to an industrial fork truck and monitor such things as engine hours and hydraulic lift hours. It is appreciated that the present invention still provides a remote telemetry unit operable in a run mode in which data is acquired from at least one sensor and transmitted by a transceiver in accordance with a value of values in one or more registers. That is, a main advantage of embodiments of the present invention is that the remote telemetry unit may be remotely programmed. A remotely programmable remote telemetry unit may be used in many applications, in addition to the industrial tank application described in specific detail above, such as a variety of inventory management and equipment monitoring applications.

Further, it is appreciated that a number of different communication channels and identity tags may be utilized to communicate with the remote telemetry unit, however, it is preferred to use the analog cellular control channel and the Internet together with the remote telemetry unit programming protocol with an array of roaming mobile identification numbers. In addition, embodiments of the present invention comprehend a web interface to allow a customer to view the monitored data by logging on to a website of the application service provider. The database at the application service provider may be implemented in a number of ways allowing various data searching and sorting techniques. In addition, the backend or application service provider may perform data filtering and diagnostics for incoming data.

It is appreciated that embodiments of the present invention provide a remote telemetry unit having one or more programmable registers (20, FIG. 1). The registers may be programmed remotely, and the RTU control logic 18 acquires and transmits data in accordance with the contents of the registers 20. In the example illustrated, each bit of each register has a particular meaning, and the control logic is programmed appropriately. Of course, it is appreciated that the register bits may be given different meanings, and the control logic modified appropriately. Further, additional registers and control logic may be added to provide additional functionality.

For example, an operations register may be added that includes four bits to specify transceiver duty cycle, two bits to specify monitoring frequency of external gauges, a bit to specify alarm level polarity, and a bit to specify arm product alarm. The transceiver duty cycle would then have sixteen options for duty cycle of the transceiver. Because some transceivers may have a fairly large current draw, the transceiver duty cycle options allow for reduced power consumption of the RTU while keeping the transceiver on a large portion of time. Further, in another example, additional transceiver duty cycle bits may be provided such that the transceiver may operate at different duty cycles at different times of day. For example, four bits may be provided for each two hour portion of the day (forty-eight bits total). Other variations are also possible. Similarly, the monitoring frequency of external gauges settings, using two bits, provide four options for the monitoring frequency of external gauges. As with the transceiver, different options allow the conservation of power and the monitoring of the processes at different frequencies. Further, additional bits and/or registers may be provided to monitor at different frequencies at different times of day. Further, the alarm level polarity bit sets whether the alarm is triggered on the rising or the falling edge. Further in the example, the arm product alarm bit determines whether the RTU will transmit a warning when the alarm level is breached. Of course, the description above is exemplary, and any number of additional registers 20 and/or bits may be provided to add functionality to the RTU. In the example above, energy consumption (duty cycle) may be varied in accordance with stored values. Similarly, monitoring frequency may be varied.

It is appreciated that any number of additional program registers may be added to the RTU. In addition, some of the program registers may be modified or removed, etc. It is appreciated that a benefit of embodiments of the present invention is the remote programmability of the RTU and the fact that the RTU has one or more programmable registers 20. Further, for example, several transmission schedule registers may be added. A transmission schedule register set could provide a “reset counter” command. In addition, a set of transmission schedule registers would allow the exact time and date that the transmission cycle begins to be set (as opposed to having to perform a reset counter at a specified time). That is, one or more transmission schedule registers provides enhanced functionality over the “reset counter” command, however, whether it is appropriate to have a reset counter command and/or a transmission schedule register depends upon the particular application as is appreciated by one of ordinary skill in the art. Lastly, one or more time and date registers may be provided to allow the time and date to be set on an internal RTU clock. The above examples of additional registers that may be added to an RTU are not meant to be an exhaustive list. As such, it is appreciated that many other different registers 20 may be added to provide enhanced functionality and flexibility for the RTU in accordance with the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A wireless telemetry system comprising:
a remote telemetry unit including a transceiver, control logic, at least one programmable register holding a value, and at least one sensor, the remote telemetry unit being operable in a run mode in which data is acquired from the at least one sensor and transmitted by the transceiver in accordance with the value in the at least one register, and in a program mode, the transceiver having a first group of identity tags and a second group of identity tags, wherein receipt by the transceiver of a call to an identity tag in the first group causes the remote telemetry unit to enter the program mode, and wherein receipt by the transceiver of a call to an identity tag in the second group when the remote telemetry unit is in the program mode causes the control logic to modify the value in the at least one register.

2. The system of claim 1 wherein the first group of identity tags includes a plurality of identity tags.

3. The system of claim 1 wherein the second group of identity tags includes a plurality of identity tags.

4. The system of claim 1 wherein the at least one register includes a plurality of registers, the first group of identity tags including a first tag and a second tag,
wherein when the remote telemetry unit is in the run mode, receipt by the transceiver of a call to the first tag causes the at least one sensor to acquire data and the transceiver to transmit the data, and receipt by the transceiver of a call to the second tag causes the remote telemetry unit to switch from the run mode to the program mode, and
wherein when the remote telemetry unit is in the program mode, receipt by the transceiver of a call to the first tag causes the transceiver to change a selected register of the plurality of registers, and receipt by the transceiver of a call to the second tag causes the remote telemetry unit to switch from the program mode to the run mode.

5. The system of claim 1 wherein the at least one register includes a plurality of bits, the second group of identity tags including a corresponding plurality of tags, and
wherein when the remote telemetry unit is in the program mode, receipt by the transceiver of a call to one of the tags in the second group of tags causes the corresponding bit to toggle, changing the value held in the at least one register.

6. The system of claim 1 wherein the at least one register includes an operations register having bits that specify at least one of the following: frequency of regularly scheduled transmissions, unit interrogation request, switch systems, retrieve memory, reset counters, transceiver duty cycle, monitoring frequency, transmission schedule, and time and date.

7. The system of claim 1 wherein the at least one register includes at least one alarm register corresponding to the at least one sensor, the register having bits that specify an alarm level for the at least one sensor.

8. The system of claim 1 wherein the at least one register includes a fill alarm register having bits that specify a fill alarm level.

9. The system of claim 1 further comprising:
a backend server that receives a message indicative of the data transmitted by the transceiver.

10. The system of claim 9 wherein the backend server is in communication with the Internet to allow access to the data via the Internet.

11. A wireless telemetry system comprising:
a remote telemetry unit including a cellular transceiver, control logic, at least one programmable register holding a value, and at least one sensor, the remote telemetry unit being operable in a run mode in which data is acquired from the at least one sensor and transmitted by the transceiver in accordance with the value in the at least one register, and in a program mode, the transceiver having a first group of mobile identification numbers and a second group of mobile identification numbers, wherein receipt by the transceiver of a call to a mobile identification number in the first group causes the remote telemetry unit to enter the program mode, and wherein receipt by the transceiver of a call to a mobile identification number in the second group when the remote telemetry unit is in the program mode causes the control logic to modify the value in the at least one register.

12. The system of claim 11 wherein the first group of mobile identification numbers includes a plurality of mobile identification numbers.

13. The system of claim 11 wherein the second group of mobile identification numbers includes a plurality of mobile identification numbers.

14. The system of claim 11 wherein the at least one register includes a plurality of registers, the first group of mobile identification numbers including a first number and a second number,
wherein when the remote telemetry unit is in the run mode, receipt by the transceiver of a call to the first number causes the at least one sensor to acquire data and the transceiver to transmit the data, and receipt by the transceiver of a call to the second number causes the remote telemetry unit to switch from the run mode to the program mode, and
wherein the remote telemetry unit is in the program mode, receipt by the transceiver of a call to the first number causes the transceiver to change a selected register of the plurality of registers, and receipt by the transceiver of a call to the second number causes the remote telemetry unit to switch from the program mode to the run mode.

15. The system of claim 11 wherein the at least one register includes a plurality of bits, the second group of mobile identification numbers including a corresponding plurality of numbers, and
wherein when the remote telemetry unit is in the program mode, receipt by the transceiver of a call to one of the numbers in the second group of numbers causes the corresponding bit to toggle, changing the value held in the at least one register.

16. The system of claim 11 wherein the at least one register includes an operations register having bits that specify at least one of the following: frequency of regularly scheduled transmissions, unit interrogation request, switch systems, retrieve memory, reset counters, transceiver duty cycle, monitoring frequency, transmission schedule, and time and date.

17. The system of claim 11 wherein the at least one register includes at least one alarm register corresponding to the at least one sensor, the register having bits that specify an alarm level for the at least one sensor.

18. The system of claim 11 wherein the at least one register includes a fill alarm register having bits that specify a fill alarm level.

19. The system of claim 11 further comprising:
a backend server that receives a message indicative of the data transmitted by the transceiver.

20. The system of claim 11 wherein the cellular transceiver is configured to transmit the acquired data over a cellular control channel.
